(19) United States
(12) Patent Application Publication
(10) Pub. No.: US 2026/0202597 A1
(43) Pub. Date: Jul. 16, 2026

(54) Optical Article Including Curved Optical Film

(71) Applicant: 3M INNOVATIVE PROPERTIES COMPANY, St. Paul, MN (US)

(72) Inventors: Benjamin G. Sonnek, Mahtomedi, MN (US); Steven J. McMan, Stillwater, MN (US); Stephen R. Alexander, Stillwater, MN (US); Abel Ebongue, Paris (FR); Jonah Shaver, St. Paul, MN (US)

(21) Appl. No.: 19/134,849

(22) PCT Filed: Dec. 1, 2023
(86) PCT No.: PCT/IB2023/062150

§ 371 Date: Jun. 2, 2025

Related U.S. Application Data
(60) Provisional application No. 63/433,043, filed on Dec. 16, 2022.

(51) Int. Cl. G02B 5/30; B29D 11/00

(52) U.S. Cl. CPC G02B 5/3033; B29D 11/00788; G02B 5/3083

(57) ABSTRACT

An optical article includes a curved optical film wrapped about a central axis so that opposing first and second ends of the curved optical film join and form a seam therebetween. The curved optical film has an average thickness of less than about 500 microns and an average optical transmittance of greater than about 40% for a substantially normally incident light, for at least one polarization state, and for a first wavelength in a wavelength range extending from about 420 nm to about 1550 run. In a first cross-section of the curved optical film in a first plane that includes the central axis, the optical film has opposing first and second curved cross-sectioned portions. Across a middle 60% of at least one of the first and second curved cross-sectioned portions, the cross-sectioned portion has a minimum radius of curvature Rimin of less than about 15 cm.

### TECHNICAL FIELD

The present description relates generally relates to articles including curved optical films.

### BACKGROUND

An optical film can be thermoformed into a desired shape.

### SUMMARY

In some aspects, the present description provides an optical article including a curved optical film wrapped about a central axis so that opposing first and second ends of the curved optical film join and form a seam therebetween. The seam extends between opposite top and bottom of the curved optical film spaced apart by a distance H. The curved optical film has an average thickness of less than about 500 microns and an average optical transmittance of greater than about 40% for a substantially normally incident light, for at least one polarization state, and for a first wavelength in a wavelength range extending from about 420 nm to about 1550 nm. The curved optical film is such that, in a first cross-section of the curved optical film in a first plane that comprises the central axis, the curved optical film has opposing first and second curved cross-sectioned portions. Across a middle 60% of at least one of the first and second curved cross-sectioned portions, the cross-sectioned portion has: a minimum radius of curvature R1min of less than about 15 cm; and for the first wavelength, an average in-plane index of refraction Navg, and a maximum in-plane birefringence DN, where DN/Navg can be no more than about 0.04.

In some aspects, the present description provides an optical article including a curved optical film wrapped so that opposing first and second ends of the curved optical film join and form a seam therebetween. The seam extends from an open top to an opposite open bottom of the curved optical film. The open top and bottom include respective open top and open bottom perimeters. The curved optical film can have an average thickness of less than about 500 microns and an average optical transmittance of greater than about 40% for a substantially normally incident light, for at least one polarization state, and for a first wavelength in a wavelength range extending from about 420 nm to about 1550 nm, such that: a minimum distance between the open top and bottom perimeters is S1min; and a shortest path on the curved optical film between the open top and bottom perimeters is S2min, where S2min/S1min≥1.05.

In some aspects, the present description provides a process for shaping an optical film. The process includes: cutting a substantially flat polymeric optical film into a first film having a substantially annulus-sector shape; wrapping the first film so that opposing first and second ends of the first film join and form a seam, where the seam extends from an open top to an opposite open bottom of the wrapped first film, and where the open top and bottom includes respective open top and open bottom perimeters; fixing positions of the open top and open bottom perimeters such that a minimum distance between the open top and bottom perimeters is S1min; heating the first film; and expanding the heated first film with the open top and open bottom perimeters fixed to provide a curved optical film such that a shortest path on the curved optical film between the open top and bottom perimeters is S2min, where S2min/S1min can be greater than or equal to 1.05.

These and other aspects will be apparent from the following detailed description. In no event, however, should this brief summary be construed to limit the claimable subject matter.

### BRIEF DESCRIPTION OF THE DRAWINGS

FIGS. 1-2 are schematic top and bottom perspective views, respectively, of an optical article including a curved optical film, according to some embodiments.

FIG. 3 is a schematic side view of an optical film, according to some embodiments.

FIG. 4 is a schematic cross-sectional view of an optical film in a first plane, according to some embodiments.

FIG. 5 is a schematic cross-sectional view of the optical article in a second plane, according to some embodiments.

FIG. 6A is a schematic top view of an optical film, according to some embodiments.

FIG. 6B schematically illustrates expanding a wrapped optical film, according to some embodiments.

FIG. 6C is a schematic cutaway perspective view of a mold for shaping an optical film, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some embodiments of the present description, an optical article includes an optical film that has been wrapped into a conical-frustrum shape and then radially expanded into a desired curved shape. It has been found, according to some embodiments, that optical films shaped in this way can have a lower in-plane birefringence (referring to the birefringence in a tangent plane) than when formed to a similar average radius of curvature using other methods such as expanding a flat film into a three-dimensional shape as described in U.S. Pat. Appl. Pub. No. 2020/0241187 (Jennings et al.), for example, when the film before forming has a low in-plane birefringence. It has been found, according to some embodiments, that the processes of the present description can allow an optical film to be formed into geometries that cannot be obtained by previous methods without degrading desired properties of the optical film by (locally) over stretching the film, for example. Further, it has been found, according to some embodiments, that optical films curved as described herein can have a lower variation in thickness and/or a lower variation in in-plane birefringence than when formed to a similar average radius of curvature using previous methods.

In some embodiments, a portion of the curved optical film is cut from the optical article for use in another optical article. The cut portion can be useful as a cover for an optical component, for example. In some embodiments, it is desired that such films have a low in-plane birefringence so that the polarization state of substantially normally incident light is not substantially changed when transmitted through the optical film. In some embodiments, the optical film is a reflective polarizer, and the cut potion may be disposed on an optical lens (e.g., the optical lens can be molded onto the cut portion), for example, to provide an optical construction that can be useful in optical systems such as those of U.S. Pat. No. 10,678,052 (Ouderkirk, et al.), for example.

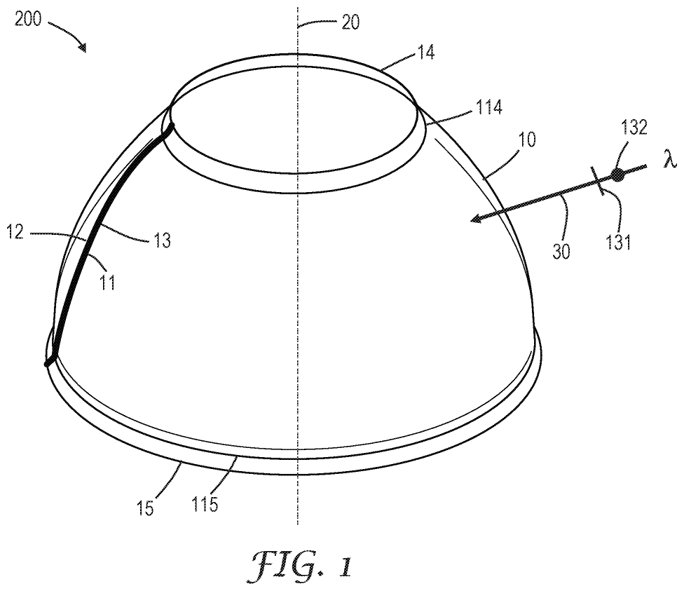

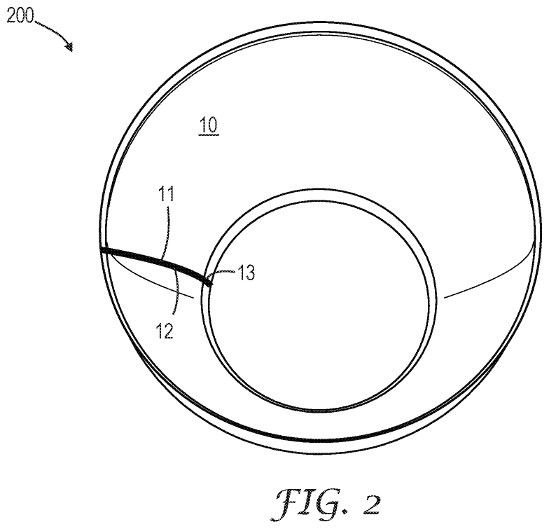

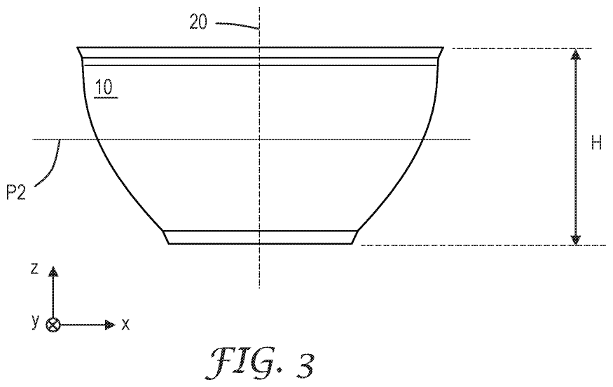

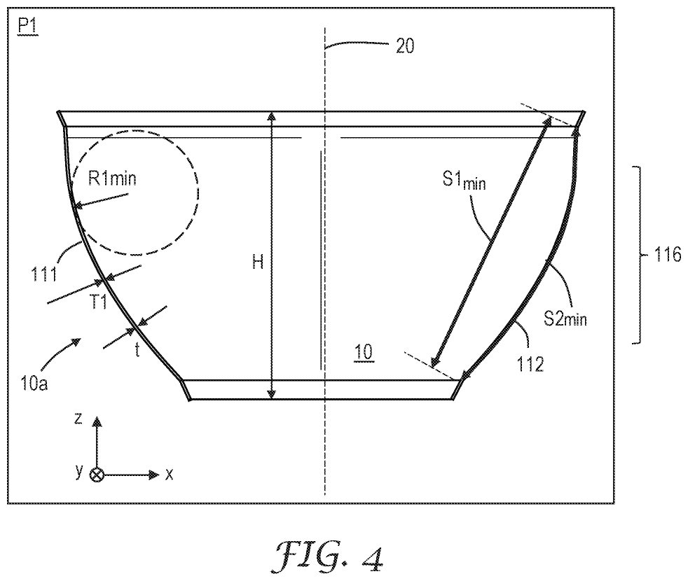

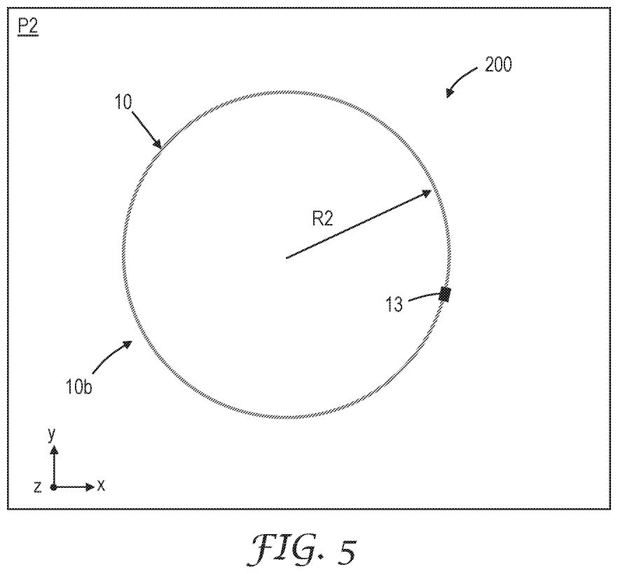

FIGS. 1-2 are schematic top and bottom perspective views, respectively, of an optical article 200 including a curved optical film 10, according to some embodiments. FIG. 3 is a schematic side view of the optical film 10, according to some embodiments. FIG. 4 is a schematic cross-sectional view of the optical film 10 in a first plane P1, according to some embodiments. FIG. 5 is schematic cross-sectional view of the optical article 200 in a second plane P2 that can be substantially orthogonal (e.g., within about 30, 20, 10, or 5 degrees of orthogonal) to the first plane P1, according to some embodiments.

In some embodiments, an optical article 200 includes a curved optical film 10 wrapped so that opposing first and second ends 11 and 12 of the curved optical film 10 join and form a seam 13 therebetween. For example, in some embodiments, the curved optical film 10 is wrapped about a central axis 20 so that opposing first and second ends 11 and 12 of the curved optical film join and form a seam 13 therebetween. The first and second ends 11 and 12 can be joined by a piece of tape, for example, to form the seam 13. In some embodiments, the seam 13 extends between opposite top 14 and bottom 14 and 15 of the curved optical film spaced apart by a distance H. In some embodiments, the seam extends from an open top 14 to an opposite open bottom 15 of the curved optical film where the open top 14 and open bottom 15 include respective open top and open bottom perimeters 114 and 115 (see, e.g., FIG. 1). The open top and open bottom perimeters 114 and 115 can correspond to a crease, for example, in the top and bottom of the film 10 caused by a clamp, for example, in the forming of the film into a curved shape. The curved optical film 10 can be a polymeric optical film.

In some embodiments, the curved optical film 10 has an average thickness t of less than about 500, or 450, or 400, or 350, or 300, or 250, or 200, or 150, or 100, or 75, or 50, or 40, or 30, or 20, or 10 microns. In some embodiments, the average thickness t is greater than about 1, 5, 10, 20, 30, 40, or 50 microns. In some embodiments, the average thickness t is in a range of about 1 micron to about 500 microns, or about 5 microns to about 400 microns, or about 10 microns to about 300 microns, or about 20 microns to about 250 microns, or about 30 microns to about 200 microns, for example.

In some embodiments, the curved optical film 10 has an average (e.g., over a surface of the optical film 10) optical transmittance of greater than about 40%, or 50%, or 60%, or 70%, or 80% for a substantially normally (e.g., within about 30, 20, 10, or 5 degrees of normal) incident light 30, for at least one polarization state 131 and/or 132, and for a first wavelength 2 (e.g., 532 nm, 550 nm, or 637 nm) in a wavelength range extending from about 420 nm to about 1550 nm. The first wavelength 2 can be a visible wavelength in a visible wavelength range of about 420 nm to about 700 nm or to about 680 nm, for example, or can be a near-infrared wavelength in a near-infrared wavelength range of about 700 nm to about 1550 nm, for example. In some embodiments, the curved optical film 10 has an average (e.g., over wavelength and over a surface of the optical film 10) optical transmittance of greater than about 40%, or 50%, or 60%, or 70%, or 80% for a substantially normally incident light 30, for at least one polarization state 131 and/or 132 in a wavelength range extending from about 420 nm to about 1550 nm, or in a near-infrared wavelength range extending from about 700 nm to about 1550 nm, or in a visible wavelength range extending from about 420 nm to about 680 nm, for example. In some embodiments, the at least one polarization state is a first polarization state 131. In some embodiments, the at least one polarization state includes orthogonal first and second polarization states 131 and 132. In some embodiments, the curved optical film 10 has an average (e.g., over wavelength, over polarization state, and over a surface of the optical film 10) optical transmittance of greater than about 40%, or 50%, or 60%, or 70%, or 80% for a substantially normally incident unpolarized light 30 in a wavelength range extending from about 420 nm to about 1550 nm, or in a near-infrared wavelength range extending from about 700 nm to about 1550 nm, or in a visible wavelength range extending from about 420 nm to about 680 nm. For example, the optical film can be a substantially transparent polymeric film such as a polyethylene terephthalate (PET) film. The film can optionally be coated and/or surface treated, for example. Illustrative surface treatments and coatings are described in U.S. Pat. Appl. Pub. No. 2022/0177303 (Thompson et al.), for example. Such surface treatments and coatings can be useful to provide a hydrophobic (or superhydrophobic or superomniphobic) outer surface to a curved optical film used as protective covering for an electronic device, for example.

In some embodiments, for a substantially normally incident light 30 and a visible wavelength range extending from about 420 nm to about 680 nm, the curved optical film 10 has an average (e.g., over wavelength and over a surface of the optical film 10) optical transmittance of greater than about 40% for a first polarization state 131 and may have an average (e.g., over wavelength and over a surface of the optical film 10) optical reflectance of greater than about 40% for a second polarization state 132 orthogonal to the first polarization state 131. The average optical transmittance for the first polarization state 131 can be greater than about 50%, or 60%, or 70%, or 80%. The average optical reflectance for the second polarization state 132 can be greater than about 50%, or 60%, or 70%, or 80%, or 90%. For example, in some embodiments, for the substantially normally incident light 30, the curved optical film 10 has an average optical transmittance in the visible wavelength range of greater than about 60% for a first polarization state 131 and an average optical reflectance in the visible wavelength range of greater than about 60% for a second polarization state 132 orthogonal to the first polarization state 131. The optical film can be a reflective polarizer film as generally described in U.S. Pat. No. 5,882,774 (Jonza et al.); 6,783,349 (Neavin et al.); 6,949,212 (Merrill et al.); 6,967,778 (Wheatley et al.); and 9,162,406 (Neavin et al.), for example.

In some embodiments, the curved optical film 10 is such that, in a first cross-section 10a (see, e.g., FIG. 4) of the curved optical film in a first plane (P1 or xz-plane referring to the illustrated x-y-z coordinate system) that comprises the central axis 20, the optical film 10 has opposing first and second curved cross-sectioned portions 111 and 112, where across a middle (e.g., middle portion 116) 60% of at least one of the first and second curved cross-sectioned portions 111, 112, the cross-sectioned portion has: a minimum radius of curvature R1min of less than about 15, or 14, or 13, or 12, or 11, or 10, or 9, or 8, or 7, or 6, or 5 cm. In some such embodiments, or in other embodiments, the minimum radius of curvature R1min is greater than about 0.5, 0.75, 1, 1.25, 1.5, 1.75, 2, 2.5, 3, 3.5, or 4 cm.

In some such embodiments, or in other embodiments, across the middle (e.g., middle portion 116) 60% of at least one of the first and second curved cross-sectioned portions 111, 112, the cross-sectioned portion has: an average in-plane index of refraction Navg and a maximum in-plane birefringence DN, where DN/Navg is no more than about 0.04. In some such embodiments, or in other embodiments, DN/Navg is no more than about 0.035, 0.03, 0.025, 0.02, 0.019, 0.018, 0.017, 0.016, 0.015, 0.014, or 0.013. The indices of refraction can be evaluated at the same first wavelength (e.g., 532 nm, 550 nm, or 637 nm) in the wavelength range extending from about 420 nm to about 1550 nm used in characterizing the optical transmittance of the optical film. The in-plane birefringence at a location of the optical film is the birefringence in a plane tangent to the optical film at the location.

In some embodiments, the optical film is a monolithic single layer film and the in-plane index of refraction of the optical film is the in-plane index of refraction of the single layer. The in-plane birefringence can be low (e.g., less than about 0.05) in this case even when there is a large out-of-plane birefringence (e.g., greater than about 0.1). In some embodiments, the average (over the cross-sectioned portion and averaged over directions in the plane of the film) in-plane index of refraction Navg is in a range of about 1.4 to 2, or about 1.5 to 1.8, or about 1.6 to about 1.75. In some such embodiments, or in other embodiments, the maximum (over the cross-sectioned portion) in-plane birefringence DN is less than about 0.05, 0.045, 0.04, 0.035, 0.03, or 0.025.

In some embodiments, the optical film includes a plurality of layers, and the average in-plane index of refraction of the optical film can then refer to an average within each layer averaged over the layers (e.g., a volume weighted average over the layers) and the maximum in-plane birefringence can refer to the largest in-plane birefringence over all of the layers. For example, the optical film can include a first layer being biaxially oriented and having an out-of-plane birefringence of greater than about 0.1 and an in-plane birefringence of less than about 0.05, and a second layer being a coating, for example, and having an isotropic refractive index. In this case, DN can refer to the maximum in-plane birefringence of the first layer, Navg can refer to the average in-plane indices of refraction averaged over the first and second layers, and DN/Navg can be in any of the ranges described elsewhere herein (e.g., DN/Navg may be no more than about 0.04). In other embodiments, the plurality of layers includes substantially uniaxially oriented layers, for example, which can have substantially higher DN values (e.g., greater than 0.06, 0.08, or 0.1). In some such embodiments, or in other embodiments, DN/Navg may be greater than 0.04, 0.06, 0.08, or 0.1, for example.

In some embodiments, R1min and/or DN/Navg is in any of the ranges described elsewhere herein for a middle 65%, or 70%, 75%, or 80%, or 85%, or 90%, or 95% of the at least one of the first and second curved cross-sectioned portions. For example, in some embodiments, in the first cross-section 10a, across a middle 70% of the at least one of the first and second curved cross-sectioned portions, the cross-sectioned portion has: a minimum radius of curvature R1min′ of less than about 12 cm; and for the first wavelength λ, an average in-plane index of refraction Navg′, and a maximum in-plane birefringence DN′, where DN′/Navg′ is no more than about 0.03 (a prime symbol ′ may be used to distinguish quantities defined over different middle portions). As another example, in some embodiments, in the first cross-section 10a, across a middle 80% of the at least one of the first and second curved cross-sectioned portions, the cross-sectioned portion has: a minimum radius of curvature R1min′ of less than about 10 cm; and for the first wavelength λ, an average in-plane index of refraction Navg′, and a maximum in-plane birefringence DN′, where DN′/Navg′ is no more than about 0.02. The minimum radius of curvature R1min, Navg, and/or DN can be different in different middle portions (e.g., R1min′, Navg′, and/or DN′ in the middle 80% of the at least one of the first and second curved cross-sectioned portions can be different than R1min, Navg, and/or DN, respectively, in the middle 60% of the at least one of the first and second curved cross-sectioned portions). The middle 60%, for example, of a curved cross-sectioned portion refers to the middle 60% along the height direction (z-direction) by length along the cross-sectioned portion.

Refractive indices and birefringence can be determined using a prism coupler such as a Metricon Model 2010/M prism coupler. The in-plane birefringence can alternatively be determined by measuring an in-plane retardance using a polarimeter such as an AXOMETRICS AXOSCAN Mueller matrix polarimeter, for example, and dividing by the film thickness at the same location that the retardance is measured.

In some embodiments, the curved optical film 10 is such that a minimum distance between the open top and bottom perimeters is S1min; and a shortest path on the curved optical film between the open top and bottom perimeters is S2min, where S2min/S1min≥1.05, 1.06, 1.07, 1.08, 1.09, or 1.1. In some embodiments, S2min/S1min≤1.2, 1.19, 1.18, 1.17, 1.16, 1.15, 1.14, 1.135, or 1.13. For example, in some embodiments, S2min/S1min is in a range of about 1.05 to about 1.2, or about 1.06 to about 1.18, or about 1.07 to about 1.16, or about 1.08 to about 1.14.

In some embodiments, across the middle portion (e.g., the middle 60% or the middle 70% or another middle portion) of the at least one of the first and second curved cross-sectioned portions, the cross-sectioned portion has an average thickness T1 (see, e.g., FIG. 4) and a thickness standard deviation ST1 (e.g., schematically represented by any difference between T1 and t in FIG. 4), where ST1/T1≤0.2, or 0.15, or 0.1, or 0.09, or 0.08, or 0.07, or 0.06, or 0.05, or 0.04, or 0.03, or 0.02, or 0.01.

In some embodiments, across the middle portion (e.g., the middle 60% or the middle 70% or another middle portion) of the at least one of the first and second curved cross-sectioned portions, the cross-sectioned portion has a minimum radius of curvature R1min, where H/R1min≥0.2, or 0.25, or 0.3, or 0.35, or 0.375, or 0.4, or 0.45, or 0.55, or 0.6, or 0.7, or 0.8, or 0.9, or 1, or 1.1, or 1.2, or 1.3. In some embodiments, H/R1min≤2, 1.9, 1.8, 1.7, 1.6, 1.5.

In some embodiments, H≥5, or 6, or 7, or 8, or 9, or 10, or 15, or 20, or 25, or 30, or 40, or 50 mm. In some such embodiments, or in other embodiments, H≤200, 150, 100, 90, 80, 70 mm.

In some embodiments, in a second cross-section 10b (see, e.g., FIG. 5) of the curved optical film 10 in a second plane (P2 or xy-plane) that is perpendicular to the central axis 20 and substantially bisects the curved optical film 10, the optical film 10 has an average radius of curvature R2 of greater than about 5, or 6, or 7, or 8, or 9, or 10, or 15, or 20, or 25, or 30, or 40, or 50 mm and less than about 400, or 375, or 350, or 325, or 300, or 275, or 250, or 225, or 200, or 175, or 150, or 125, or 100, or 75 mm. In some embodiments, R2 is in a range of about 5 mm to about 400 mm, or about 7 mm to about 350 mm, or about 10 mm to about 300 mm, or about 15 mm to about 250 mm, or about 20 mm to about 200 mm, for example. The optical film 10 is bisected by the second plane P2 when the plane is halfway between the top and bottom 14 and 15 of the optical film 10 along a height direction (z-direction) of the film. The optical film 10 is substantially bisected by the second plane P2 when the plane is halfway between the top and bottom 14 and 15 of the optical film 10 up to about 30, 25, 20, 15, 10, or 5% of H, for example.

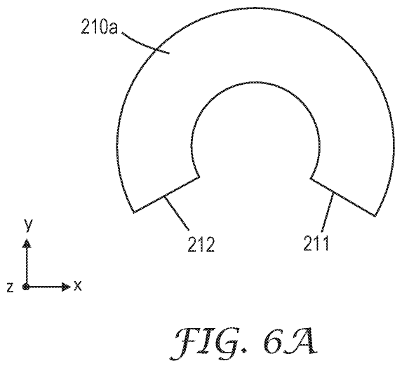

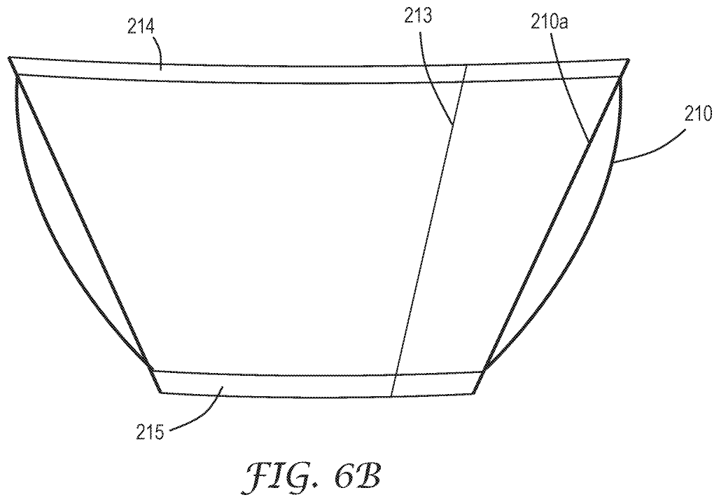

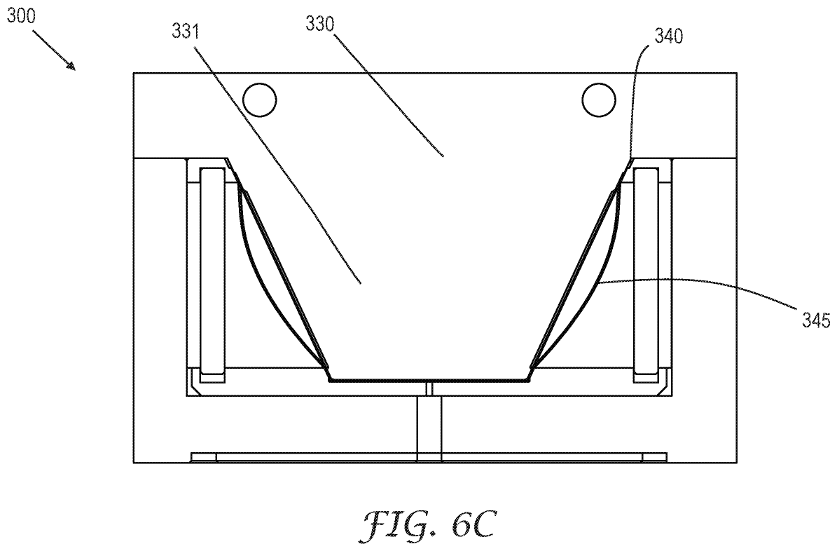

FIGS. 6A-6C schematically illustrates a process for forming an initially unstretched first film 210a into a curved optical film 210 (e.g., corresponding to optical film 10), according to some embodiments. The optical film 210a, 210 can have any of the optical properties described elsewhere herein. In some embodiments, a process for shaping an optical film includes cutting a substantially flat polymeric optical film into a first film having a substantially annulus-sector shape (see, e.g., FIG. 6A); wrapping the first film 210a so that opposing first and second ends 211 and 212 of the first film 210a join and form a seam 213 (see, e.g., FIG. 6B), where the seam extends from an open top to an opposite open bottom (e.g., corresponding to 14 and 15) of the wrapped first film and where the open top and bottom includes respective open top and open bottom perimeters 214 and 215; fixing positions of the open top and open bottom perimeters (e.g., in the mold 300 schematically illustrated in FIG. 6C) such that a minimum distance between the open top and bottom perimeters is S1min (see, e.g., FIG. 4); heating the first film; and expanding the heated first film with the open top and open bottom perimeters fixed to provide a curved optical film such that a shortest path on the curved optical film between the open top and bottom perimeters is S2min (see, e.g., FIG. 4), where S2min/S1min≥1.05 or S2min/S1min can be in a range described elsewhere herein.

A film can have a shape substantially that of a given geometry (e.g., flat, annulus section, conical frustum) if the film nominally has that geometry or has that geometry up to variations small (e.g., less than about 15, 10, or 5%) compared to a largest dimension of the shaped film.

Wrapping the first film can include wrapping the first film into a truncated conical shape (conical frustum) substantially without stretching the film. For example, the film can be wrapped around a conical-frustrum-shaped portion 331 of a mold platen 330 in a mold 300. Expanding the film can include expanding the film radially away from the central axis 20 (see, e.g., FIG. 3). Heating the first film 210a can include heating the mold platen 330 which heats the film. The first film 201a can be heated to a temperature greater than a glass transition temperature Tg of the first film (e.g., greater than a Tg of at least one layer of the film or greater than a Tg of each of the layers). In some embodiments, the first film 201a is semicrystalline and has a range of melting temperatures. The first film 201a can be heated to a temperature less than the largest melting point of the optical film. In some embodiments, the first film 201 is heated to a temperature of about equal to, or even greater than, a lowest melting temperature of a range of melting temperatures of the first film 201a. In some embodiments, the first film 210a can be a polyethylene terephthalate film having a glass transition temperature of about 70 degrees C and a melting point in a range of about 240 to about 260 degrees C and the first film can be heated to a temperature of about 150 to about 250 degrees C, or about 180 to about 220 degrees C, for example. Air pressure can be applied to the outside of the film 210a to press the film against the conical-frustrum-shaped portion 331 of the mold platen 330 to aid in heating the film. For example, a porous insert 340 can be included in mold 300 to allow air to be injected. After the film 201a has been heated, expanding the film can include applying air to the inside of the film through the mold platen 330 in order to force the film outward, stretching it against a curved mold surface 345, for example, into a desired geometry.

### EXAMPLES

An approximately 125 micron thick biaxially oriented polyethylene terephthalate (PET) film was thermoformed into the shape schematically illustrated in FIGS. 1-5, for example, using the process described for FIGS. 6A-6C. Before forming, the film had an out-of-plane index of refraction of 1.491, and average in-plane index of refraction of 1.658, and an average in-plane birefringence of 0.031 at 637 nm as measured using a Metricon Model 2010/M prism coupler. The film was cut into the shape of an annulus sector and wrapped into a conical frustrum shape. The ends of the film were taped together to form a seam. The film was expanded in a mold as schematically illustrated in FIG. 6C. The film was heated to about 190 degrees C before expanding. Air was injected through porous insert 340 to hold the film adjacent the conical-frustrum-shaped portion 331 of a mold platen 330 to aid in heating the film. To expand the film, air was injected through the mold platen 330 to press the film against the curved mold surface 345. After thermoforming, the curved optical film had a R1min of about 4.3 cm, an H of about 6.1 cm, an R2 of about 5.7 cm, an average thickness of about 109.5 microns and a standard deviation of thickness of about 0.941 microns. The thermoformed film had an out-of-plane birefringence of 1.488, and average in-plane birefringence of 1.659, an average in-plane birefringence of 0.0176, and a maximum in-plane birefringence of 0.0205 at 637 nm as measured using a Metricon Model 2010/M prism coupler. The thermoformed film had a maximum in-plane birefringence of 0.0232 at 550 nm as measured using a AXOMETRICS AXOSCAN Mueller matrix polarimeter to determine in-plane retardance and dividing the retardance by the thickness of the layer at the measured location. The polarimeter was used with a spectrally selective source and the Mueller matrix was collected at a series of wavelengths across the visible spectrum. The spectrum was then analyzed by the polarimeter software to unwrap the absolute retardation at each wavelength. The maximum birefringence was determined using the prism coupler and the polarimeter over an area excluding the perimeters 114 and 115.

A film including an approximately 63 micron thick biaxially oriented PET film that included an approximately 71 micron thick coating as generally described in U.S. Pat. Appl. Pub. No. 2022/0177303 (Thompson et al.) was thermoformed as described for the approximately 125 micron thick PET film. The film was wrapped so that the coating faced the outside of the curved optical film. Before thermoforming, the PET layer of the film had an out-of-plane index of refraction of 1.495, and average in-plane index of refraction of 1.659, and an average in-plane birefringence of 0.023 at 637 nm as measured using a Metricon Model 2010/M prism coupler. After thermoforming, the PET layer of the film had an out-of-plane index of refraction of 1.495, an average in-plane index of refraction of 1.656, an average in-plane birefringence of 0.0198, and a maximum in-plane birefringence of 0.022 at 637 nm as measured using a Metricon Model 2010/M prism coupler.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. An optical article comprising a curved optical film wrapped about a central axis so that opposing first and second ends of the curved optical film join and form a seam therebetween, the seam extending between opposite top and bottom of the curved optical film spaced apart by a distance H, the curved optical film having an average thickness of less than about 500 microns and an average optical transmittance of greater than about 40% for a substantially normally incident light, for at least one polarization state, and for a first wavelength in a wavelength range extending from about 420 nm to about 1550 nm,
such that, in a first cross-section of the curved optical film in a first plane that comprises the central axis, the curved optical film has opposing first and second curved cross-sectioned portions, wherein across a middle 60% of at least one of the first and second curved cross-sectioned portions, the cross-sectioned portion has:
a minimum radius of curvature R1min of less than about 15 cm; and
for the first wavelength, an average in-plane index of refraction Navg, and a maximum in-plane birefringence DN, DN/Navg being no more than about 0.04.

2. The optical article of claim 1, wherein in the first cross-section, across a middle 70% of the at least one of the first and second curved cross-sectioned portions, the cross-sectioned portion has:
a minimum radius of curvature R1min′ of less than about 12 cm; and
for the first wavelength, an average in-plane index of refraction Navg′, and a maximum in-plane birefringence DN′, DN′/Navg′ being no more than about 0.03.

3. The optical article of claim 1, wherein the top and bottom of the curved optical film comprises respective open top and open bottom perimeters, such that:
a minimum distance between the open top and bottom perimeters is S1min; and
a shortest path on the curved optical film between the open top and bottom perimeters is S2min, 1.2≥S2min/S1min≥1.05.

4. The optical article of claim 1, wherein the minimum radius of curvature R1min is greater than about 1 cm.

5. The optical article of claim 1, wherein across the middle 60% of the at least one of the first and second curved cross-sectioned portions, the cross-sectioned portion has an average thickness T1 and a thickness standard deviation ST1, ST1/T1≤0.2.

6. The optical article of claim 1, wherein H/R1min≥0.2.

7. The optical article of claim 6, wherein H/R1min≤2.

8. The optical article of claim 1, wherein H≥5 mm.

9. The optical article of claim 8, wherein H≤200 mm.

10. The optical article of claim 1, wherein in a second cross-section of the curved optical film in a second plane that is perpendicular to the central axis and substantially bisects the curved optical film, the curved optical film has an average radius of curvature R2 of greater than about 5 mm and less than about 400 mm.

11. An optical article comprising a curved optical film wrapped so that opposing first and second ends of the curved optical film join and form a seam therebetween, the seam extending from an open top to an opposite open bottom of the curved optical film, the open top and bottom comprising respective open top and open bottom perimeters, the curved optical film having an average thickness of less than about 500 microns and an average optical transmittance of greater than about 40% for a substantially normally incident light, for at least one polarization state, and for a first wavelength in a wavelength range extending from about 420 nm to about 1550 nm, such that:
a minimum distance between the open top and bottom perimeters is S1min; and
a shortest path on the curved optical film between the open top and bottom perimeters is S2min, S2min/S1min≥1.05.

12. The optical article of claim 11, wherein S2min/S1min≤1.15.

13. The optical article of claim 11, wherein the at least one polarization state comprises orthogonal first and second polarization states.

14. The optical article of claim 11, wherein for the substantially normally incident light, the curved optical film has an average optical transmittance in a visible wavelength range of about 420 nm to about 680 nm of greater than about 60% for a first polarization state and an average optical reflectance in the visible wavelength range of greater than about 60% for a second polarization state orthogonal to the first polarization state.

15. A process for shaping an optical film, the process comprising:
cutting a substantially flat polymeric optical film into a first film having a substantially annulus-sector shape;
wrapping the first film so that opposing first and second ends of the first film join and form a seam, the seam extending from an open top to an opposite open bottom of the wrapped first film, the open top and bottom comprising respective open top and open bottom perimeters;
fixing positions of the open top and open bottom perimeters such that a minimum distance between the open top and bottom perimeters is S1min;
heating the first film; and
expanding the heated first film with the open top and open bottom perimeters fixed to provide a curved optical film such that a shortest path on the curved optical film between the open top and bottom perimeters is S2min, S2min/S1min≥1.05.
